(19) United States
(12) Patent Application Publication
(10) Pub. No.: US 2025/0142428 A1
(43) Pub. Date: May 1, 2025

(54) HANDOVER TO AN ENERGY SAVING NETWORK

(71) Applicant: Lenovo (Beijing) Limited, Beijing (CN)

(72) Inventors: Ran Yue, Beijing (CN); Lianhai Wu, Beijing (CN); Haiming Wang, Beijing (CN); Xiaodong Yu, Beijing (CN); Congchi Zhang, Shanghai (CN)

(73) Assignee: Lenovo (Beijing) Limited, Beijing (CN)

(21) Appl. No.: 18/865,767

(22) PCT Filed: May 17, 2022
(86) PCT No.: PCT/CN2022/093361

§ 371 Date: Nov. 14, 2024

(51) Int. Cl. H04W 36/00

(52) U.S. Cl. CPC H04W 36/008357; H04W 36/0061; H04W 36/0079

(57) ABSTRACT

Methods and apparatuses for handover with new cell being involved are disclosed. A base unit comprises a processor; and a transceiver coupled to the processor, wherein, the processor is configured to receive, via the transceiver, a preference of handover of a UE for target base unit; and perform handover of the UE according to the preference of handover of the UE.

### FIELD

The subject matter disclosed herein generally relates to wireless communications, and more particularly relates to methods and apparatuses for handover to an energy saving network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Reference Signal Receiving Power (RSRP), Reference Signal Receiving Quality (RSRQ), Radio Access Technology (RAT), Master information block (MIB), System Information Block (SIB), non-access-stratum (NAS), Ultra-reliable Low-latency Communication (URLLC).

When a UE in connected (e.g. RRC_CONNECTED) state performs handover, the UE switches from its serving cell (i.e. source cell) to another cell (i.e. target cell).

A UE that supports the feature of network energy saving techniques may be referred to as new UE. A UE that does not support the feature of network energy saving techniques may be referred to as legacy UE. A base unit that supports the feature of network energy saving techniques may be referred to as new base unit. A base unit that does not support the feature of network energy saving techniques may be referred to as legacy base unit. A base unit can be represented by a gNB or a cell. That is, new base unit can be represented by new cell.

In the prior art, there is no disclosure on how to identify the new cell and the legacy cell. In addition, when the handover is performed, no criterion is related to selecting a new cell.

This invention targets handover with new cell being involved.

### BRIEF SUMMARY

Methods and apparatuses for handover with new cell being involved are disclosed.

In one embodiment, a UE comprises a processor; and a transceiver coupled to the processor, wherein, the processor is configured to transmit, via the transceiver, a preference of handover of the UE for target base unit to a base unit; and receive, via the transceiver, a handover message from the base unit, wherein the handover message is formed in view of the preference of handover of the UE for target base unit.

In some embodiment, the preference of handover of the UE for target base unit includes at least one of: preference for a target new base unit that implements network energy saving techniques or preference for a target legacy base unit that does not implement network energy saving techniques; support of a state of the new base unit; preference for a target new base unit in sleep state or preference for a target new base unit in non-sleep state; and preference for a target new base unit in one of the sleep states.

In one embodiment of handover initiated by the base unit (e.g. source base unit, or source cell), the handover message includes an indication of a target base unit, and the processor is configured to handover the UE to the target base unit.

In another embodiment of conditional handover initiated by the UE, the handover message includes handover-related information of target base units; and the processor is further configured to perform handover to a target base unit according to its handover-related information. The handover-related information of each target base unit includes at least one of: the target base unit is a new base unit that implements network energy saving techniques or a legacy base unit that does not implement network energy saving techniques; a state of the target base unit, which is the new base unit; a sleep state of the target base unit, which is the new base unit; and related configuration of the target base unit.

In another embodiment, a method performed by a UE comprises transmitting a preference of handover of the UE for target base unit to a base unit; and receiving a handover message from the base unit, wherein the handover message is formed in view of the preference of handover of the UE for target base unit.

In yet another embodiment, a base unit comprises a processor; and a transceiver coupled to the processor, wherein, the processor is configured to receive, via the transceiver, a preference of handover of a UE for target base unit; and perform handover of the UE according to the preference of handover of the UE. The preference of handover of the UE for target base unit includes at least one of: preference for a target new base unit that implements network energy saving techniques or preference for a target legacy base unit that does not implement network energy saving techniques; support of a state of the new base unit; preference for a target new base unit in sleep state or preference for a target new base unit in non-sleep state; and preference for a target new base unit in one of the sleep states.

In some embodiment, the processor is configured to handover the UE to a target base unit that fulfills the preference of handover of the UE.

In some embodiment, the processor is further configured to transmit, via the transceiver, the preference of handover of the UE for target base unit to candidate target base units. In particular, the processor is configured to transmit, via the transceiver, the preference of handover of the UE for target base unit only to candidate target base units that fulfill the preference of handover of the UE.

In some embodiment, the processor is further configured to receive, via the transceiver, handover-related information of a target base unit from the target base unit. In particular, the handover-related information of each target base unit includes at least one of: the target base unit is a new base unit that implements network energy saving techniques or a legacy base unit that does not implement network energy saving techniques; a state of the target base unit, which is the new base unit; a sleep state of the target base unit, which is the new base unit; and related configuration of the target base unit.

In some embodiment, the processor is configured to transmit, via the transceiver, handover-related information of candidate target base units to the UE to perform handover of the UE.

In some embodiment, the processor is further configured to transmit, via the transceiver, handover reject information to a target base unit if the target base unit does not fulfill the preference of handover of the UE. In particular, the processor is configured to transmit, via the transceiver, the handover reject information to the target base unit in a new message or in an existing message with a new cause value, or in an existing message with new information element.

In still another embodiment, a method performed by a base unit comprises receiving a preference of handover of a UE for target base unit; and performing handover of the UE according to the preference of handover of the UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example scenario of new cell involved in handover;

FIG. 2 illustrates an example scenario of new cell in sleep state and new cell in non-sleep state involved in handover;

FIG. 3 is a schematic flow chart diagram illustrating an embodiment of a method;

FIG. 4 is a schematic flow chart diagram illustrating another embodiment of a method;

FIG. 5 is a schematic flow chart diagram illustrating a further embodiment of a method; and

FIG. 6 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

A UE in connected (e.g. RRC_CONNECTED) state is served by at least one cell (i.e. serving cell) that includes a primary cell. It means that, for each of the at least one cell, the UE communicates with the gNB of the cell. Accordingly, a cell can be represented by a gNB. In other words, new cell can be represented by new gNB (or new gNB/cell) or new base unit; while legacy cell can be represented by legacy gNB (or legacy gNB/cell) or legacy base unit.

For clarification, in the following description, if appropriate, new cell is used to represent new gNB, or new gNB/cell, or new base unit; and legacy cell is used to represent legacy gNB, or legacy gNB/cell, or legacy gNB/cell.

A new cell and a legacy cell can be neighboring cells. It means that the coverage of the new cell and the coverage of the legacy cell may be overlapped, while the UE in the overlapped area of neighboring cells may handover (i.e. switch) to either the new cell or the legacy cell in handover.

Handover (HO) means that a UE served by a primary cell (e.g. source cell) is switched to another cell (e.g. target cell). The source cell configures the UE to perform measurement and send measurement report. The source cell, based on the measurement report sent by the UE (e.g. a measured RSRP or RSRQ is lower than a threshold), determines to handover the UE to one target cell. The source cell determines the one target cell by sending a handover request (e.g. Handover Request message) to multiple potential target cells (e.g. neighboring cells satisfying a predetermined condition, e.g. the quality of the neighboring cell is good). For example, the source cell may determine any of the potential target cells sending back a handover request acknowledge (e.g. HANDOVER REQUEST ACKNOWLEDGE) as the one target cell. In other words, any potential target cell that sending back a handover preparation failure (e.g. HANDOVER PREPARATION FAILURE message) cannot be determined as the one target cell The above-described procedures belong to handover preparation phase. It can be seen that a potential target cell, when receiving the handover request from the source cell, may send back a handover request acknowledge which means that the source cell can handover the UE to the potential target cell, or alternatively send back a handover preparation failure which means that the source cell cannot handover the UE to the potential target cell.

In handover execution phase following the handover preparation phase, the source cell sends an RRCReconfiguration message to the UE to trigger the handover of the UE, i.e. to handover the UE to the determined one target cell.

A conditional handover (CHO) is defined as a handover that is executed by the UE. In the handover preparation phase of CHO, the source cell, based on the measurement report sent by the UE (e.g. a measured RSRP or RSRQ is lower than a threshold), determines to use CHO. The source cell sends a CHO request (e.g. CHO request message) to each of candidate target cells (e.g. neighboring cells satisfying a predetermined condition, e.g. the quality of the neighboring cell is good), and receives a CHO response from each of the candidate target cells. The CHO response may be HO request acknowledge which means that the UE can handover to the candidate target cell in a CHO execution condition, or HO preparation failure which means that the UE cannot handover to the candidate target cell. The source cell forms a CHO configuration which includes all of the candidate target cells sending back an HO request acknowledge and their CHO execution conditions. In the handover execution phase of CHO, the source cell sends, to the UE, an RRCReconfiguration message containing the CHO configuration. The UE, upon determining one CHO execution condition being met, handovers to one candidate target cell associated with the one CHO execution condition. In addition, the one candidate target cell sends a handover success (e.g. HANDOVER SUCCESS message) to the source cell to inform the source cell that the UE has successfully accessed the one candidate target cell. The source cell may also send a handover cancel message (e.g. HANDOVER CANCEL message) to each of other candidate target cell(s) contained in the CHO configuration (than the one candidate target cell to which the UE handovers).

In the following description, the potential target cell is also referred to as candidate target cell.

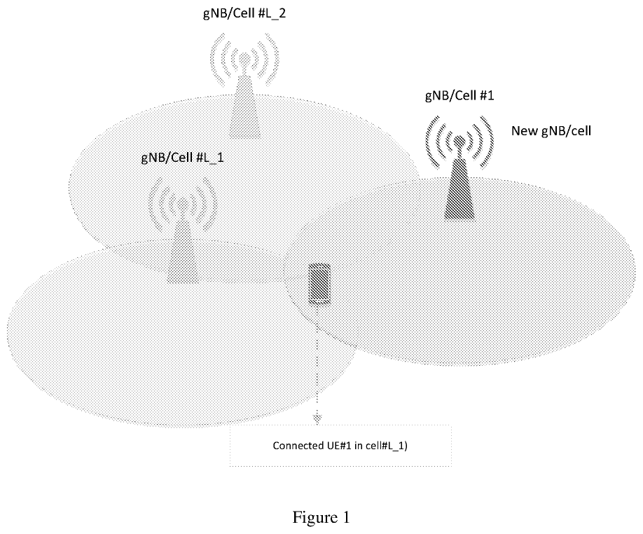

In an example scenario illustrated in FIG. 1, the serving cell of UE #1, which is in connected state and is a new UE, is cell#L_1 (which is a legacy cell). UE#1 attempts to handover (i.e. switch) from its serving cell (e.g. source cell) to a neighboring cell (e.g. target cell). The neighboring cells include cell#L_2 (which is a legacy cell) and cell#1 (which is a new cell). The question is: if the new UE#1 has a preference for the target cell (e.g. UE#1 prefers a new cell, or UE#1 prefers a legacy cell), how can the new UE#1 switch to the preferred target cell?

The new cell, which supports the feature of network energy saving techniques, may be in non-sleep state (e.g. normal state, active state, etc) or in sleep state. A new gNB/cell is in sleep state means the new gNB/cell is in the state of low energy consumption. There could be multiple sleep states, for example micro sleep state, light sleep state, deep sleep state, etc. Each of the sleep states corresponds to a different level of energy consumption. The different level of energy consumption may be represented by different state transition time, or by different reference parameters or different configurations or different configuration periods, or by different levels of TX power, or by different levels of power consumption, or by different levels of resource allocation, etc. Each of different levels may be less than 100%. A new gNB/cell is in non-sleep state means the new gNB/cell can utilize the full level of energy. Correspondingly, the state transition time, or TX power, or power consumption, or resource allocation, etc in non-sleep state can be less than or equal to 100% or can be higher than the level in sleep state.

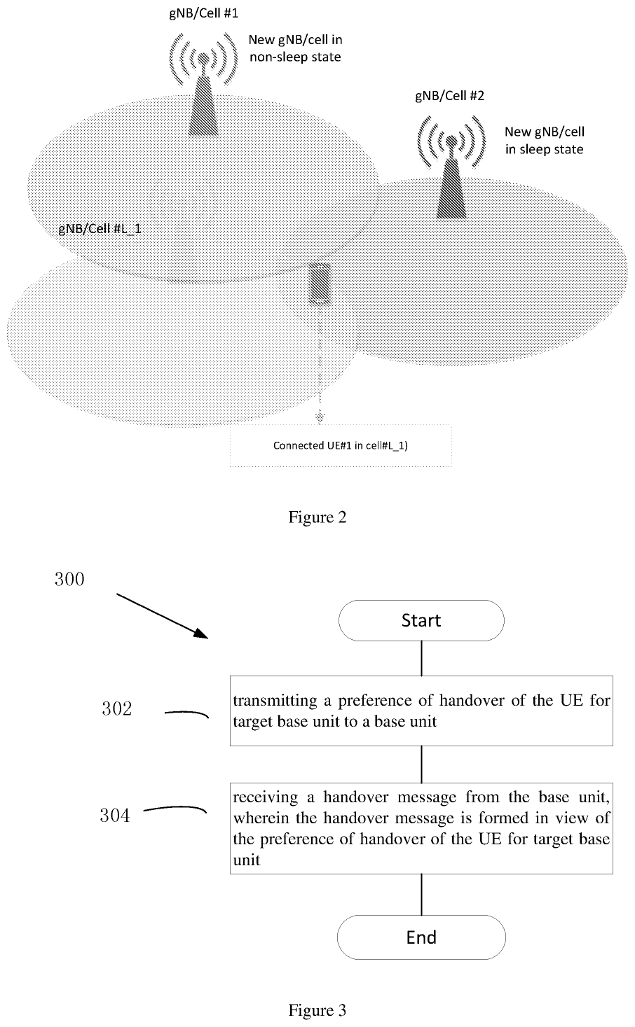

In an example scenario illustrated in FIG. 2, the serving cell of UE#1, which is in connected state and is a new UE, is cell#L_1 (which is a legacy cell). UE#1 attempts to handover (i.e. switch) to a neighboring cell (e.g. a target cell). The neighboring cells include cell#1 (which is a new cell in non-sleep state) and cell#2 (which is a new cell in sleep state). The question is: if the new UE#1 has a preference for the target new cell (e.g. UE#1 prefers a new cell in non-sleep state, or UE#1 prefers a new cell in sleep state), how can the new UE#1 switch to the preferred target cell?

This disclosure proposes different solutions related to handover when new cell(s) are involved.

A first embodiment relates to enhancement in Uu interface.

Uu interface is an interface between the UE and the base unit (e.g. gNB or cell).

UE may provide a preference of handover to the source cell over Uu interface.

The preference of handover may include at least one of the following:
(1) preference for a target new cell or preference for a target legacy cell;
(2) support of the state (i.e. sleep state(s) and non-sleep state) of the new cell;
(3) preference for a target new cell in sleep state or preference for a target new cell in non-sleep state (e.g. UE cannot access to a new cell in the sleep state(s)); and
(4) preference for a target new cell in one of the sleep states (e.g. one of micro sleep state, light sleep state, and deep sleep state).

The preference of handover may be indicated in an enumeration manner.

For example, if the preference of handover only includes preference for a target new cell or preference for a target legacy cell, 1 bit can be used to indicate whether the UE prefers a target new cell or a target legacy cell. For example, ‘0’ indicates preference for the target new cell and ‘1’ indicates preference for the target legacy cell. Alternatively, ‘1’ indicates preference for the target new cell and ‘0’ indicates preference for the target legacy cell.

For another example, if the preference of handover includes the above-described (1) and (3), two bits may be used. For example, ‘00’ indicates preference for a target new cell in sleep state(s), ‘01’ indicates preference for a target new cell in non-sleep state, and ‘10’ or ‘11’ indicates preference for a target legacy cell.

The preference of handover may be provided to the source cell by being contained in a UL transmission, e.g. in a configured measurement report, or in a UE capability report.

Alternatively, the preference of handover can be implicitly provided to the source cell by UE capability report. For example, if a UE capability report indicates that the UE supports network energy saving techniques, it can be considered as the preference of handover of the UE is preference for a target new cell. For another example, if a UE capability report indicates that the UE supports all of the states of the cell which implements energy saving techniques, it can be considered as the preference of handover of the UE is preference for a target new cell or preference for any state of a target new cell. Further, if the UE explicitly provides its preference of handover after the UE capability report, the explicitly provided preference of handover will replace the implicitly provided preference of handover.

The source cell may indicate the handover-related information of the target cell to UE over Uu interface.

The handover-related information may include at least one of the following:
(1) the target cell is a new cell or a legacy cell;
(2) the state of the target new cell (e.g. sleep state or non-sleep state);
(3) the sleep state of the target new cell (e.g. one of micro sleep state, light sleep state, and deep sleep state); and
(4) the related configuration of the target cell, e.g. the periodicity of the SSB and/or SIB.

The handover-related information can be indicated to UE in the handover execution phase, e.g. in the handover command. For example, the source cell sends an RRCReconfiguration message containing the handover-related information to UE.

A second embodiment relates to behaviors of the source cell.

The source cell can be a new cell or a legacy cell. The source cell can identify the preference of handover of the UE for target cell, e.g. by receiving the preference of handover of the UE for target cell from the UE.

The source cell may send the preference of handover of a UE to a target cell (any candidate target cell). The preference of handover can be sent to the target cell (e.g. target new cell) in a handover preparation phase, e.g. by being included in the handover request.

Preferably, the source cell may send the preference of handover of the UE only to the target cell that fulfills the preference of handover of the UE.

For example, if the preference of handover of the UE indicates a preference of the new cell in non-sleep state (e.g. would not access to a target new cell in a specific state, for example in the sleep state or in one of the sleep states), the source cell may only send the preference of handover of the UE (e.g. by being included in the handover request) to the candidate target cells that are a new cell in non-sleep state, but may not send the preference of handover of the UE to other candidate target cell(s) that are not a new cell in non-sleep state.

Alternatively, the source cell may also send the preference of handover of the UE to the target cell that does not fulfill the preference of handover of the UE. For example, if the preference of handover of the UE indicates a preference of the new cell in non-sleep state, the source cell may still send the preference of handover of the UE to candidate target cell(s) that are not a new cell in non-sleep state.

When the source cell identifies the preference of handover of a UE, the source cell may send a handover request only to each of the candidate target cells that fulfill the preference of handover of the UE, if the source cell can identify that there is at least one candidate target cell that fulfills the preference of handover of the UE.

For example, if the UE can access to a new cell (e.g. preference for a target new cell), if there is at least one candidate target cell being new cell, the handover request is only sent to the candidate target new cells. Similarly, if the UE can access to a new cell in a specific state (e.g. preference for a target new cell in a specific state), if there is at least one candidate target cell being new cell in the specific state, the handover request is only sent to the candidate target new cells in the specific state.

Among multiple candidate target cells, candidate target new cells can be prioritized than candidate target legacy cells. It means that a candidate target new cell (i.e. any of the candidate target new cells) is prioritized to be determined as the target cell (or target new cell). Similarly, among candidate target new cells in different states, candidate target new cells in a specific state can be prioritized than candidate target new cells in other state(s). It means that a candidate target new cell in the specific state (i.e. any of the candidate target new cells in the specific state) is prioritized to be determined as the target cell (or target new cell).

After receiving the handover request acknowledge from a candidate target cell (e.g. a candidate target new cell), the source cell may send, to the candidate target cell, handover reject information to reject candidate target cell if the state of the candidate target call is unacceptable, e.g. in one of the following conditions:
(1) the candidate target cell is in a different state from the state when the handover request was sent;
(2) the candidate target cell is in a different state from a previously reported state;
(3) the candidate target cell indicates a potential state transition; and
(4) the candidate target cell is in a state that is unacceptable by the UE.

The handover reject information can be sent to the candidate target cell in one of the following manners:
(1) in a new message, e.g. handover reject message;
(2) with a new cause value (e.g. unacceptable state), the new cause value can be included in an existing message (e.g. handover cancel message); and
(3) with a new information element (IE) (e.g. state indication), the new IE can be included in an existing message (e.g. handover cancel message).

A third embodiment relates to behaviors of the target cell.

The new cell can inform, to its neighboring cells, information on that the new cell itself supports the feature of network energy saving techniques. This can be done before the new cell receives the handover request. In addition, the new cell can also inform, to its neighboring cells, its state (e.g. sleep state or non-sleep state). If the state (e.g. sleep state or non-sleep state) of the new cell changes, the new cell may inform its changed state to its neighboring cells.

A candidate target new cell, when receiving the handover request from a source cell, is required to inform, to the source cell, information on that the candidate target new cell itself supports the feature of network energy saving techniques. In addition, the candidate target new cell can also inform, to the source cell, its current state (e.g. sleep state or non-sleep state).

The new cell can inform, to its neighboring cells, information on that the new cell itself supports the feature of network energy saving techniques. This can be done before the new cell receives the handover request. When receiving the handover request from a source cell, the candidate target new cell is required to inform, to the source cell, its current state (e.g. sleep state or non-sleep state).

After receiving the HO request or the CHO request from the source cell, the candidate target new cell may respond with handover reject information to reject handover if the state the candidate target new cell is not appropriate, e.g. in one of the following conditions:
(1) the candidate target new cell in a different state from the state when the handover request was received (e.g. after receiving the handover request and before responding to the handover request, the state of the candidate target new cell changes);
(2) the candidate target new cell is in a different state from the previously reported state;
(3) the candidate target new cell is in a potential state transition (i.e. will be changed to another state); and
(4) the candidate target new cell is in a state that is unacceptable by the UE.

The handover reject information can be sent to the source cell in one of the following manners:
(1) in a new message, e.g. handover reject message;
(2) in an existing message (e.g. handover preparation failure or handover request acknowledge) with a new cause value (e.g. unacceptable state); and
(3) in an existing message (e.g. handover preparation failure or handover request acknowledge) with new information element (e.g. state indication).

FIG. 3 is a schematic flow chart diagram illustrating an embodiment of a method 300 according to the present application. In some embodiments, the method 300 is performed by an apparatus, such as a remote unit (UE). In certain embodiments, the method 300 may be performed by a processor executing program code, for example, a microcontroller, a microprocessor, a CPU, a GPU, an auxiliary processing unit, a FPGA, or the like.

The method 300 may be performed by a UE and comprise 302 transmitting a preference of handover of the UE for target base unit to a base unit; and 304 receiving a handover message from the base unit, wherein the handover message is formed in view of the preference of handover of the UE for target base unit.

In some embodiment, the preference of handover of the UE for target base unit includes at least one of: preference for a target new base unit that implements network energy saving techniques or preference for a target legacy base unit that does not implement network energy saving techniques; support of a state of the new base unit; preference for a target new base unit in sleep state or preference for a target new base unit in non-sleep state; and preference for a target new base unit in one of the sleep states.

In one embodiment of handover initiated by the base unit (e.g. source base unit, or source cell), the handover message includes an indication of a target base unit, and the method 300 comprises handovering the UE to the target base unit.

In another embodiment of conditional handover initiated by the UE, the handover message includes handover-related information of target base units; and the method 300 further comprises performing handover to a target base unit according to its handover-related information. The handover-related information of each target base unit includes at least one of: the target base unit is a new base unit that implements network energy saving techniques or a legacy base unit that does not implement network energy saving techniques; a state of the target base unit, which is the new base unit; a sleep state of the target base unit, which is the new base unit; and related configuration of the target base unit.

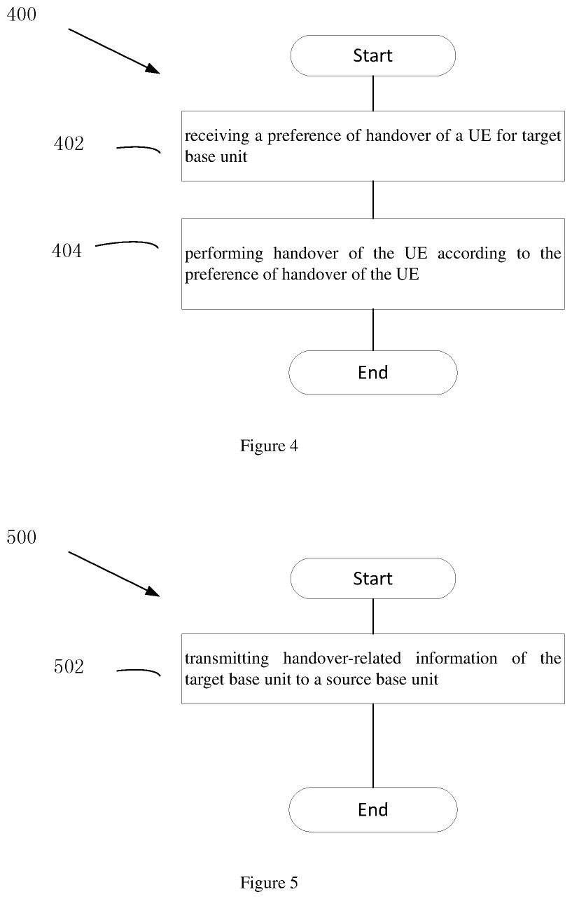

FIG. 4 is a schematic flow chart diagram illustrating a further embodiment of a method 400 according to the present application. In some embodiments, the method 400 is performed by an apparatus, such as a base unit or a network device. In certain embodiments, the method 400 may be performed by a processor executing program code, for example, a microcontroller, a microprocessor, a CPU, a GPU, an auxiliary processing unit, a FPGA, or the like.

The method 400 may be performed by a base unit (e.g. source base unit) and comprises: 402 receiving a preference of handover of a UE for target base unit; and 404 performing handover of the UE according to the preference of handover of the UE. The preference of handover of the UE for target base unit includes at least one of: preference for a target new base unit that implements network energy saving techniques or preference for a target legacy base unit that does not implement network energy saving techniques; support of a state of the new base unit; preference for a target new base unit in sleep state or preference for a target new base unit in non-sleep state; and preference for a target new base unit in one of the sleep states.

In some embodiment, the method 400 comprises handovering the UE to a target base unit that fulfills the preference of handover of the UE.

In some embodiment, the method 400 further comprises transmitting the preference of handover of the UE for target base unit to candidate target base units. In particular, the method 400 comprises transmitting the preference of handover of the UE for target base unit only to candidate target base units that fulfill the preference of handover of the UE.

In some embodiment, the method 400 further comprises receiving handover-related information of a target base unit from the target base unit. In particular, the handover-related information of each target base unit includes at least one of: the target base unit is a new base unit that implements network energy saving techniques or a legacy base unit that does not implement network energy saving techniques; a state of the target base unit, which is the new base unit; a sleep state of the target base unit, which is the new base unit; and related configuration of the target base unit.

In some embodiment, the method 400 comprises transmitting handover-related information of candidate target base units to the UE to perform handover of the UE.

In some embodiment, the method 400 further comprises transmitting handover reject information to a target base unit if the target base unit does not fulfill the preference of handover of the UE. In particular, the method 400 comprises transmitting the handover reject information to the target base unit in a new message or in an existing message with a new cause value, or in an existing message with new information element.

FIG. 5 is a schematic flow chart diagram illustrating a further embodiment of a method 500 according to the present application. In some embodiments, the method 500 is performed by an apparatus, such as a base unit or a network device. In certain embodiments, the method 500 may be performed by a processor executing program code, for example, a microcontroller, a microprocessor, a CPU, a GPU, an auxiliary processing unit, a FPGA, or the like.

The method 500 may be performed by a base unit (e.g. target base unit) and comprises: 502 transmitting handover-related information of the target base unit to a source base unit. In particular, the handover-related information of each target base unit includes at least one of: the target base unit is a new base unit that implements network energy saving techniques or a legacy base unit that does not implement network energy saving techniques; a state of the target base unit, which is the new base unit; a sleep state of the target base unit, which is the new base unit; and related configuration of the target base unit.

In some embodiment, the method 500 further comprises receiving a preference of handover of a UE for target base unit. The preference of handover of the UE for target base unit includes at least one of: preference for a target new base unit that implements network energy saving techniques or preference for a target legacy base unit that does not implement network energy saving techniques; support of a state of the new base unit; preference for a target new base unit in sleep state or preference for a target new base unit in non-sleep state; and preference for a target new base unit in one of the sleep states.

In some embodiment, the method 500 further comprises transmitting handover reject information to a source base unit if the target base unit does not fulfill the preference of handover of the UE for target base unit. In particular, the method 500 comprises transmitting the handover reject information to the source base unit in a new message or in an existing message with a new cause value, or in an existing message with new information element.

Any base unit can be a source base unit, or a target base unit. In addition, a base unit can be both a source base unit and a target unit. It means that each of the features of the method 500 can be an additional feature of the method 400. For example, step 502 can be an additional step of the method 400. In addition, each of the features of the method 400 can be an additional feature of the method 500. For example, steps 402 and 404 can be an additional feature of the method 500.

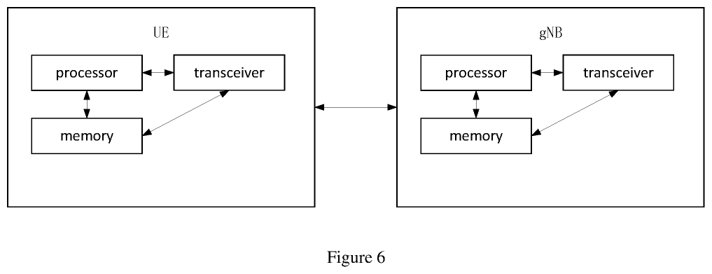

FIG. 6 is a schematic block diagram illustrating apparatuses according to one embodiment.

Referring to FIG. 6, the UE (i.e. remote unit, or terminal device) includes a processor, a memory, and a transceiver. The processor implements a function, a process, and/or a method which are proposed in FIG. 3.

The UE comprises a processor; and a transceiver coupled to the processor, wherein, the processor is configured to transmit, via the transceiver, a preference of handover of the UE for target base unit to a base unit; and receive, via the transceiver, a handover message from the base unit, wherein the handover message is formed in view of the preference of handover of the UE for target base unit.

In some embodiment, the preference of handover of the UE for target base unit includes at least one of: preference for a target new base unit that implements network energy saving techniques or preference for a target legacy base unit that does not implement network energy saving techniques; support of a state of the new base unit; preference for a target new base unit in sleep state or preference for a target new base unit in non-sleep state; and preference for a target new base unit in one of the sleep states.

In one embodiment of handover initiated by the base unit (e.g. source base unit, or source cell), the handover message includes an indication of a target base unit, and the processor is configured to handover the UE to the target base unit.

In another embodiment of conditional handover initiated by the UE, the handover message includes handover-related information of target base units; and the processor is further configured to perform handover to a target base unit according to its handover-related information. The handover-related information of each target base unit includes at least one of: the target base unit is a new base unit that implements network energy saving techniques or a legacy base unit that does not implement network energy saving techniques; a state of the target base unit, which is the new base unit; a sleep state of the target base unit, which is the new base unit; and related configuration of the target base unit.

Referring to FIG. 6, the gNB (i.e. base unit or network device) includes a processor, a memory, and a transceiver. The processor implements a function, a process, and/or a method which are proposed in FIG. 4 or FIG. 5.

The base unit (e.g. source base unit) comprises a processor; and a transceiver coupled to the processor, wherein, the processor is configured to receive, via the transceiver, a preference of handover of a UE for target base unit; and perform handover of the UE according to the preference of handover of the UE. The preference of handover of the UE for target base unit includes at least one of: preference for a target new base unit that implements network energy saving techniques or preference for a target legacy base unit that does not implement network energy saving techniques; support of a state of the new base unit; preference for a target new base unit in sleep state or preference for a target new base unit in non-sleep state; and preference for a target new base unit in one of the sleep states.

In some embodiment, the processor is configured to handover the UE to a target base unit that fulfills the preference of handover of the UE.

In some embodiment, the processor is further configured to transmit, via the transceiver, the preference of handover of the UE for target base unit to candidate target base units. In particular, the processor is configured to transmit, via the transceiver, the preference of handover of the UE for target base unit only to candidate target base units that fulfill the preference of handover of the UE.

In some embodiment, the processor is further configured to receive, via the transceiver, handover-related information of a target base unit from the target base unit. In particular, the handover-related information of each target base unit includes at least one of: the target base unit is a new base unit that implements network energy saving techniques or a legacy base unit that does not implement network energy saving techniques; a state of the target base unit, which is the new base unit; a sleep state of the target base unit, which is the new base unit; and related configuration of the target base unit.

In some embodiment, the processor is configured to transmit, via the transceiver, handover-related information of candidate target base units to the UE to perform handover of the UE.

In some embodiment, the processor is further configured to transmit, via the transceiver, handover reject information to a target base unit if the target base unit does not fulfill the preference of handover of the UE. In particular, the processor is configured to transmit, via the transceiver, the handover reject information to the target base unit in a new message or in an existing message with a new cause value, or in an existing message with new information element.

The base unit (e.g. target base unit) comprises a processor; and a transceiver coupled to the processor, wherein, the processor is configured to transmit, via the transceiver, handover-related information of the target base unit to a source base unit. In particular, the handover-related information of each target base unit includes at least one of: the target base unit is a new base unit that implements network energy saving techniques or a legacy base unit that does not implement network energy saving techniques; a state of the target base unit, which is the new base unit; a sleep state of the target base unit, which is the new base unit; and related configuration of the target base unit.

In some embodiment, the processor is further configured to receive, via the transceiver, a preference of handover of a UE for target base unit. The preference of handover of the UE for target base unit includes at least one of: preference for a target new base unit that implements network energy saving techniques or preference for a target legacy base unit that does not implement network energy saving techniques; support of a state of the new base unit; preference for a target new base unit in sleep state or preference for a target new base unit in non-sleep state; and preference for a target new base unit in one of the sleep states.

In some embodiment, the processor is further configured to transmit, via the transceiver, handover reject information to a source base unit if the target base unit does not fulfill the preference of handover of the UE for target base unit. In particular, the processor is configured to transmit, via the transceiver, the handover reject information to the source base unit in a new message or in an existing message with a new cause value, or in an existing message with new information element.

Any base unit can be a source base unit, or a target base unit. In addition, a base unit can be both a source base unit and a target unit. It means that each of the features of the source base unit can be an additional feature of the target base unit, and each of the features of the target base unit can be an additional feature of the source base unit.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A base unit for wireless communications, comprising:
at least one memory; and
at least one processor coupled with the at least one memory and configured to cause the base unit to:
receive a preference of a handover of a user equipment (UE) to a target base unit; and
perform the handover of the UE according to the preference of the handover of the UE.

2. The base unit of claim 1, wherein, the preference of the handover of the UE to the target base unit includes at least one of:
a first preference for one of a new target base unit that implements network energy saving techniques or a legacy target base unit that does not implement the network energy saving techniques;
support of a state of the new target base unit; or
a second preference for the new target base unit in one of a sleep state or a non-sleep state.

3. The base unit of claim 1, wherein, the at least one processor is configured to cause the base unit to handover the UE to the target base unit that fulfills the preference of the handover of the UE.

4. The base unit of claim 1, wherein, the at least one processor s configured to cause the base unit to transmit the preference of the handover of the UE to the target base unit to candidate target base units.

5. The base unit of claim 4, wherein, the at least one processor is configured to cause the base unit to transmit the preference of the handover of the UE to the target base unit only to candidate target base units that fulfill the preference of the handover of the UE.

6. The base unit of claim 1, wherein, the at least one processor is configured to cause the base unit to receive handover-related information of the target base unit from the target base unit.

7. The base unit of claim 6, wherein, the handover-related information of each target base unit includes at least one of:
the target base unit is a new target base unit that implements network energy saving techniques or a legacy target base unit that does not implement the network energy saving techniques;
a state of the target base unit, which is the new target base unit;
a sleep state of the target base unit, which is the new target base unit; or
a related configuration of the target base unit.

8. The base unit of claim 6, wherein, the at least one processor is configured to cause the base unit to transmit the handover-related information of candidate target base units to the UE to perform the handover of the UE.

9. The base unit of claim 1, wherein, the at least one processor is configured to cause the base unit to transmit handover reject information to the target base unit if the target base unit does not fulfill the preference of the handover of the UE.

10. The base unit of claim 9, wherein, the at least one processor is configured to cause the base unit to transmit the handover reject information to the target base unit in a new message or in an existing message with a new cause value, or in the existing message with a new information element.

11. A method performed by a base unit, the method comprising:
receiving a preference of a handover of a user equipment (UE) to a target base unit; and
performing the handover of the UE according to the preference of the handover of the UE.

12. A user equipment (UE) for wireless communication, the UE comprising:
at least one memory; and
at least one processor coupled with the at least one memory and configured to cause the UE to:
transmit to a base unit, a preference of a handover of the UE to a target base unit; and
receive, from the base unit, a handover message based on the preference of the handover of the UE to the target base unit.

13. The UE of claim 12, wherein, the preference of the handover of the UE to the target base unit includes at least one of:
a first preference for one of a new target base unit that implements network energy saving techniques or a legacy target base unit that does not implement the network energy saving techniques;
support of a state of the new target base unit; or
a second preference for the new target base unit in one of a sleep state or a non-sleep state.

14. The UE of claim 12, wherein, the handover message includes an indication of the target base unit, and the at least one processor is configured to cause the UE to handover the UE to the target base unit.

15. The UE of claim 12, wherein:
the handover message includes handover-related information of target base units; and
the at least one processor is further configured to cause the UE to perform the handover to the target base unit according to the handover-related information.

16. A processor for wireless communication, comprising:
at least one controller coupled with at least one memory and configured to cause the processor to:
transmit, to a base unit, a preference of a handover of a user equipment (UE) to a target base unit; and
receive, from the base unit, a handover message based on the preference of the handover of the UE to the target base unit.

17. The processor of claim 16, wherein the preference of the handover of the UE to the target base unit includes at least one of:
a first preference for one of a new target base unit that implements network energy saving techniques or a legacy target base unit that does not implement the network energy saving techniques;
support of a state of the new target base unit; or
a second preference for the new target base unit in one of a sleep state or a non-sleep state.

18. The processor of claim 16, wherein the preference of the handover of the UE to the target base unit includes a preference for a new target base unit in one of multiple sleep states.

19. The processor of claim 16, wherein the handover message includes an indication of the target base unit, and the at least one controller is configured to cause the processor to handover the UE to the target base unit.

20. The processor of claim 16, wherein:
the handover message includes handover-related information of target base units; and
the at least one controller is configured to cause the processor to perform the handover to the target base unit according to the handover-related information.
